(19) United States
(12) Patent Application Publication
(10) Pub. No.: US 2010/0170139 A1
(43) Pub. Date: Jul. 8, 2010

(54) MATS FOR HOLDING FLIES OR BAITS

(76) Inventor: Zhiqiang Zhou, Wenzhou (CN)

Correspondence Address: HANLEY, FLIGHT & ZIMMERMAN, LLC, 150 S. WACKER DRIVE, SUITE 2100, CHICAGO, IL, 60606, US

(21) Appl. No.: 12/632,538

(22) Filed: Dec. 7, 2009

Related U.S. Application Data
(63) Continuation-in-part of application No. PCT/CN2008/001113, filed on Jun. 6, 2008.

(30) Foreign Application Priority Data
Jun. 6, 2007 (CN) 200710023323.2

(51) Int. Cl. A01K 97/06

(52) U.S. Cl. 43/54.1

(57) ABSTRACT

Mats for holding flies or baits are disclosed which include a holding mat body formed by foamed material and one or more shaped slot(s) separately disposed on the body. The shaped slots pass through the body along the thickness direction and one end of each shaped slot is connected with a cutting slit passing through the body along the thickness direction. The cutting slit is used to hold the hook portion or the vanes of flies or baits. The holding mat can be used to hold various flies and baits quickly and laborsavingly.

### RELATED APPLICATION

This patent arises from a continuation-in-part of PCT Ser. No. PCT/CN2008/001113, which is hereby incorporated herein by reference in its entirety.

### FIELD OF THE DISCLOSURE

The present disclosure relates to a holding mat for use in flies of the field of fly fishing and in baits or lures in the field of sport fishing.

### BACKGROUND

Fly fishing is in vogue in countries across Europe and the United States, and flies serve as fishing lures in fly fishing. Currently, commercially available fixing means for flies usually make use of the mat for holding flies as described in U.S. Pat. No. 6,079,148. Such a mat for holding flies has a holding mat body made of a foamed material, with a rectangular cut-out portion disposed on the body, and the region that is not cut out is a stepped portion corresponding to the cut-out portion. A cutting slit is provided at the stepped portion, with one end communicative with the cut-out portion via a guide slot, which is usually of the V-shape, and the other end sealed off

However, such a mat for holding flies has the following defects.

(1) Such a mat for holding flies to hold the flies is inconvenient in use. When such a mat for holding flies is used to hold the flies, it is necessary to firstly place the flies upright in the cut-out portion, then align the flies to the “V”-shaped guide slot, with the hook tips located below and toward the tail end of the “V”-shaped guide slot, and subsequently push the flies into the cutting slit. If the hook tips of the flies are placed toward the direction of the cutting slit and the cutting slit is then drawn in, the hook tips might catch the sidewall of the “V”-shaped guide slot, thereby making it impossible to keep on pushing the flies into the cutting slit, so that the holding purpose cannot be achieved and the holding mat might be damaged. It is therefore necessary for the user to confirm the orientation of the hook tips of the flies while using such a mat for holding flies before the flies are pushed into the cutting slit for fixation, and this causes great inconvenience in use to the operator. Moreover, due to insufficient external light sometimes during fly fishing, it may be difficult to confirm the orientation of the hook tips of the flies.

(2) Such a mat for holding flies cannot be universally applied, which increases the fishing costs. Since the cutting slit is extremely small, the mat for holding flies is glued to a base, and since the flies are distanced very close to the cutting slit at the front “V”-shaped guide slot during holding, the resistance is relatively high against which the flies are pushed into the cutting slit. Accordingly, holding is relatively painstaking and slow. If the cutting slit is made relatively large, relatively small-sized flies are usually not easily held and tend to detach from the cutting slit. As a result, flies of different types and specifications require different mats to match therewith, for instance, dry and wet types of flies require dry and wet mats for holding flies, streamer flies require a streamer mat for holding flies, and saltwater flies require a saltwater mat for holding flies. Therefore, it becomes a common practice for anglers to carry therewith various types of boxes containing the required types of mats for holding flies, which increases not only the occupied space but also fishing costs.

Furthermore, it is difficult for tube flies to be inserted for holding in the cutting slit of the aforementioned patent. Tube flies are usually held in lateral holes of foamed holding strips, and these holes have identical aperture diameter and are arranged in equidistance to one another. The defects rest in the facts that insertion is difficult when the tube diameter of the tube fly is larger than the aperture diameter of the lateral hole of the foamed holding strip, and that insertion is easy but holding is difficult when the tube diameter of the tube fly is smaller than the aperture diameter of the lateral hole of the foamed holding strip. The tube flies are sometimes held in strip-shaped slots perpendicularly running through the foamed material, and the strip-shaped slots are arranged in equidistance to one another. The defects of such a product rest in the fact that when the tube diameter of the tube fly is apparently larger than the strip-shaped slot, pressing-in is difficult, hairs of the tube flies are easily damaged and rearrangement is needed upon takeout, and that when the tube diameter of the tube fly is apparently smaller than the strip-shaped slot, the holding function falls short although pressing-in is easy.

In addition, there are further many different types of flies or baits that are either impossible to be held or held only with difficulty by the means of the aforementioned patent or in the prior art. These flies or baits can be divided substantially in three categories: 1) flies or baits with only one hook (with the bodies of the flies or baits integrated with the hook), such as L-shaped or R-shaped spinner bait lures, and buzz bait lures; 2) flies or baits with only one hook (with the bodies of the flies or baits connected with the hook by means of rings), such as single-hook fish-shaped baits, spoon flies and spoon bait lures—flies or baits in this category usually have fish-shaped or flat vanes or spinner baits, and the shape of the flies or baits is relatively complicated; and 3) flies or baits with one or more double or treble hook(s)—this category of flies or baits are differently sized and come in various shapes, the typical types of which include fish-shaped baits, tube flies, spoon baits, spinner baits, etc.

U.S. Pat. Pub. No. 2004/256260 describes an R-shaped (or L-shaped) box of spinner baits for the first category of flies and baits. When in use, the R-shaped (or L-shaped) spinner baits are held in one hand, a steel wire 51 and an R-shaped ring are placed in the central elongated slots at protruding edges of two plastic recesses, metal spinner vanes are then placed by the other hand into the plastic recesses, and the hook 54 is subsequently pressed in a holding strip 31 of a foamed clamping means. This technical solution is defective as follows: the steel wire 51, the R-shaped ring and the metal spinner vanes cannot be effectively fixed, and the metal spinner vanes as well as the connecting means thereof sometimes have a length of up to 8 cm, which may make the steel wire 51, the R-shaped ring and the metal spinner vanes in a swinging state in transit, so that one R-shaped (or L-shaped) spinner bait metal spinner vane and the connecting means thereof collides with another R-shaped (or L-shaped) spinner bait metal spinner vane and the connecting means thereof, thus causing damage to the surface, and even entwining amongst the vanes. In order to avoid such collision, the R-shaped (or L-shaped) spinner baits must be sufficiently spaced but this takes a lot of storage space. This technical solution is also apparently infeasible. In addition, the elastic force (around 80 degrees in general) of a steel wire itself must be overcome in order for the hook 51 to be pressed in the holding strip 31 of the foamed clamping means, and due to the relatively large elastic force, even if the hook is pressed in the holding strip 31 of the foamed clamping means, the hook might eject out of the holding strip 31 of the foamed clamping means under the action of counterforce, especially so after repeated use. If the holding strip of the foamed clamping means is made to be very tight, it will be difficult to press in the hook.

It is also currently common to place R-shaped (or L-shaped) spinner baits and buzz baits inside an injection-molded box. The box has at least one row of plastic partition boards, a row of identically spaced shallow recesses are provided at the upper portion of the partition boards, and the spinner baits and buzz baits are placed in the recesses. The defect thereof lies in the fact that in transit, one spinner bait metal vane (composite spinner baits) and its connecting means might collide with another spinner bait metal vane (composite spinner baits) and its connecting means owing to their swinging and this might damage the surface or lead to entwining or hooking of the vanes. The spacing of the baits should be made sufficiently wide in order to avoid such collision, but this takes a lot of storage space. Particularly when the lure box stands upside down or is overturned, entwining or hooking of the vanes affects the use. Moreover, it is necessary for anglers to choose different products for timely angling according to different fishing sites, water depths, weathers, temperatures and timings, but it is sometimes very difficult to differentiate such features as shapes and colors of the spinner baits (vanes) placed at the bottom of the box.

With regard to the second category, it is impossible for the products in the aforementioned patent or in the prior art to solve the technical problem of holding flies or baits.

With regard to flies or baits in the third category, a small-sized box for spinner baits is described in U.S. Pat. No. 6,789,669. Foamed holding strips of a hooked clamping means are mounted at both ends and in the middle of the injection-molded box, and metal vanes are placed between partition boards 23 and over partition boards 25 at the bottom. When in use, one hook of the treble hooks is held in hand, the metal vanes are placed between partition boards 23 and over partition boards 25 at the bottom, the treble hooks are rotated to place the hook stems inside a plastic board recess 22, and two hooks of the treble hooks are pressed by hand, so that one hook thereof is pressed in the foamed clamping means, while the two other hooks locate at the upper surface. The defects thereof rest as follows: as the treble hooks must be rotated, pressing-in is relatively laborious; as two hooks locate at the upper surface, the hand might be hurt; as the vanes are not fixed, the surface might be damaged in the swinging state during transportation; since the lure box usually has an upper lid and a lower lid, bodies of small-sized spinner baits and vanes at the upper lid will be pulled out as they are not held when the lids are opened, and this brings inconvenience to use. Moreover, this technology merely attempts to solve the problem of holding certain small-sized spinner baits and fails to address the problem of holding large-sized spinner baits.

In addition, a box for placing baits is described in CN2507258, wherein baits are placed inside a receiving slot 31, and two treble hooks of the baits are respectively held within recesses of a front soft mat and a rear soft mat. Since one of the two treble hooks of the baits is usually positioned at the belly or neck of the baits, the head of the baits will be located above the positioning slot 32 and the soft mat during holding, and even go beyond the box body, thus making the box closing impossible. Moreover, since two hooks are located at the surfaces of the front soft mat and the rear soft mat, the hand might be hurt. Furthermore, it is necessary to take the hooks by hand for holding, and this is neither convenient nor safe. In addition, placement of treble hooks of the baits is also problematic in that if the treble hooks is not placed near the tail but slightly forward, the baits will not be completely held in the receiving slot. Such a technical solution falls short of achieving the holding objective.

Simple partition boards are further employed to separate the flies or baits, but this actually does not hold the flies or baits in any reliability, as the flies or baits might be damaged during carryover, and the user might be hurt during takeout and placement.

Still another foamed protection mat (the Happy Hook Protector) in the best fishing equipment for singly protecting hooks winning the European Trade Fair of Fishing Equipment, the EFTTEX 2005 Show in Warsaw, is of flat shape, wherein a notch is in the middle for insertion of hook stems, and the mat is pressed down so that hook tips are inserted into the mat for protective purposes. However, such a product has the following defects: when the hook is relatively small and the hook stem is relatively short, the thickness of the mat will be relatively thin, and the hooks easily protrude outside of the mat to hurt the user; holding is difficult, and both holding and removing the protective mat are inconvenient. Moreover, this product still could not solve the problem of holding bodies of the baits.

### BRIEF DESCRIPTION OF THE DRAWINGS

FIG. 1 is a perspective view showing a disclosed example mat for holding flies or baits;

FIG. 2 is a cross-sectional view illustrating the holding mat shown in FIG. 1 taken along the line A-A;

FIG. 3 is a schematic view showing a fly;

FIG. 4 is a schematic view showing a bait;

FIG. 5 is a schematic view showing a method of holding a hook on the holding mat as shown in FIG. 1;

FIG. 6 is an amplified view showing Section I in FIG. 5;

FIG. 7 is a schematic view showing another method of holding a hook on the holding mat as shown in FIG. 1;

FIG. 8 is a top view showing one part of another disclosed example holding mat;

FIG. 9 is a top view showing one part of another example holding mat;

FIG. 10 is a three-dimensional view showing the holding of L-shaped spinner baits with the holding mat as shown in FIG. 9;

FIG. 11 is a schematic view showing one part of another disclosed example holding mat;

FIG. 12 is a top view showing the holding of a common bait with the holding mat as shown in FIG. 11;

FIG. 13 is a schematic view showing another disclosed example holding mat;

FIG. 14 is a schematic view showing another disclosed example holding mat; and

FIG. 15 is a schematic view showing still another disclosed example holding mat.

### DETAILED DESCRIPTION

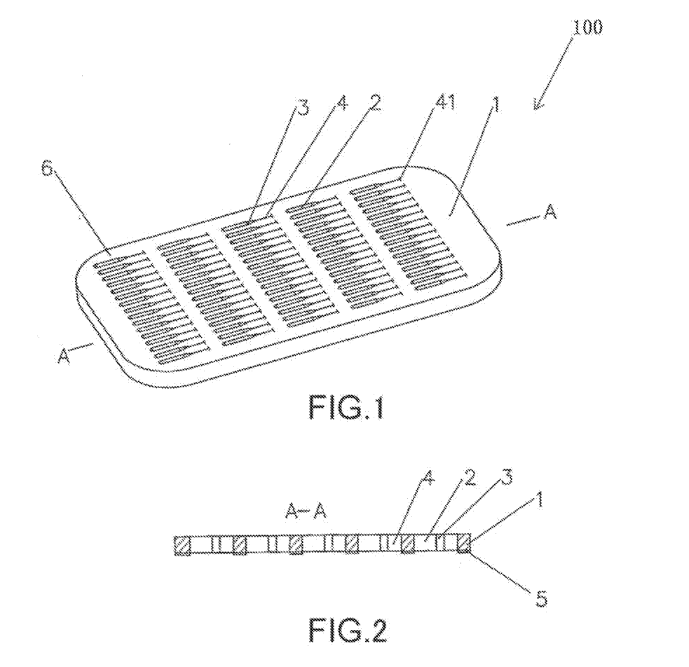

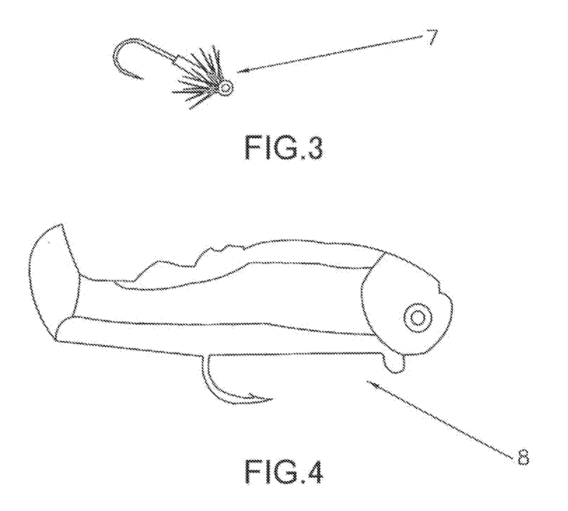

Reference is firstly made to FIGS. 1-7 to describe an example mat 100 for holding flies or baits disclosed herein. The example holding mat 100 comprises a flat cuboid holding mat body 1 made of foamed polyethylene. A plurality of independent shaped slots 2 are separately arranged in parallel on the body 1. The shaped slots 2 perpendicularly pass through the upper and lower surfaces of the body 1, so that fly 7 or bait 8 can be positioned very conveniently once an operator places the fly 7 or bait 8 in one of the shaped slot 2 without human eyes gazing at the fly for positioning, thereby facilitating operation. Under an environment with a dim light, the function is more apparent. The shaped slots 2 shown in these figures are of strip shape but they can also be such other shapes as elliptical, willow-leaf shaped, rhombic, circular or triangular.

One end of each shaped slot 2 is connected with a cutting slit 4 that perpendicularly passes through the upper and lower surfaces of the body 1, and the cutting slit 4 functions to hold the hook portion or vanes or other components similar to vanes of the flies or baits. Since the body 1 has certain elasticity, the cutting slit, under the extruding force, tends to naturally open towards both sides when the hook portion or vane is inserted into the cutting slit, thus allowing the holding of flies or baits of various sizes. No matter whether the hook portion of the flies or baits is drawn in the cutting slit 4 with its tip facing the cutting slit 4 or pushed in with the tip back against the slit 4, the hook portion can come in smoothly as the shaped slot 2, having a certain length along the longitudinal extension direction, functions to guide and accelerate the drawing-in or pushing-in process.

A guide portion 3 can be further provided between the shaped slot 2 and the cutting slit 4 connected thereto for guiding the hook portion or vanes to be inserted into the cutting slit 4. The guide portion 3 shown in these figures is of V-shape, but other proper shapes such as arc may as well serve the purpose. The guide portion 3 renders the accelerating distance of the hook portion or vane to be longer, and functions to guide so that the hook portion or vane is smoothly delivered (pressed) from the shaped slot 2 generally having a larger sectional area in the cutting slit 4 generally having a smaller sectional area.

When an inserted fly or a vane or a component part similar to the vane is relatively large in specification, the resistance of the cutting slit 4 may be unduly high for the hook portion or vane, thereby making insertion laborious. Accordingly, it is possible to provide a resistance-reducing slot 41 that intersects the cutting slit 4 at or near one end of the cutting slit 4 away from the shaped slot 2, and the resistance-reducing slit 41 also passes through the body 1 along the thickness direction of the body. Thus, the resistance-reducing slit 41 helps open the cutting slit 4, so that relatively-large flies or baits can be easily inserted into the cutting slit 4 for holding, while elasticity of the body 1 also ensures that relatively-small flies or baits do not detach. The resistance-reducing slit 41 as shown in the drawing is of a linear shape that perpendicularly intersects the cutting slit 4 at an end of the cutting slit 4, and forms a “T” shape together with the cutting slit 4. Of course, the resistance-reducing slit 41 is not limited thereto, and may also be combined with the cutting slit 4 into a “Y” shape, an arrow shape or a “+” shape.

A plurality of shaped slots 2 can be arranged in parallel to form a set of shaped slots 6, and the body 1 can be provided with a plurality of sets of shaped slots 6 arranged in parallel to each other. Each of the shaped slots 2 in the set of shaped slots 6 as shown in the drawing is identical with the others and arranged equidistance to the others. However, the teachings of the present invention are not limited thereto, as it is also possible to arrange shaped slots 2 of differing shapes and sizes at different intervals to form the set of shaped slots 6, so as to adapt to the shapes of the flies or baits to be held. This also applies to examples discussed below and their modifications.

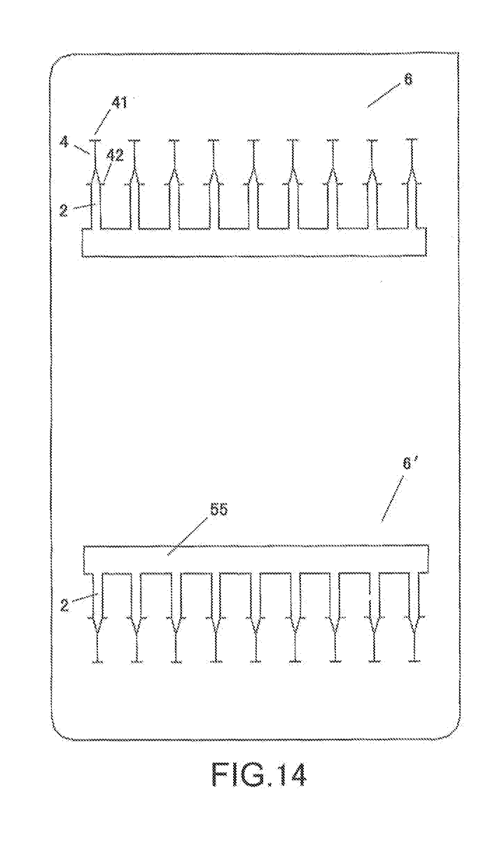

Moreover, shaped slots in adjacent sets of shaped slots 6 may be arranged opposite each other (for instance as shown in FIG. 14 below). Sets of shaped slots arranged in such a manner are particularly appropriate for holding L-shaped spinner baits, because L-shaped (or R-shaped) spinner baits usually have two portions that are distanced relatively far from each other and angled relative to each other, with one portion carrying a vane and the other portion carrying a hook portion. It is thus possible during holding to insert or push the hook portion into the cutting slit of one set of shaped slots 6, and to insert, push or press the vane into the cutting slit of the adjacent set of shaped slots 6, thereby reliably holding the L-shaped spinner baits.

As shown in FIG. 2, the holding mat can be held in an accommodating box or a panel via the binding means 5. The binding means 5 is preferably detachable, and can for instance be a double faced adhesive tape or an adhesive to facilitate replacement. As shown in FIG. 2, it is preferable that the binding means 5 is merely provided at the back and periphery of the body 1 where neither the shaped slot 2 nor the cutting slit 4 is provided, so that insertion of the hook portion or vane is not subject to the resistance inflicted by the binding means 5, and that the hook tip can be located below the body 1, thereby facilitating holding of the flies or baits. This also applies to examples discussed below and modifications thereof.

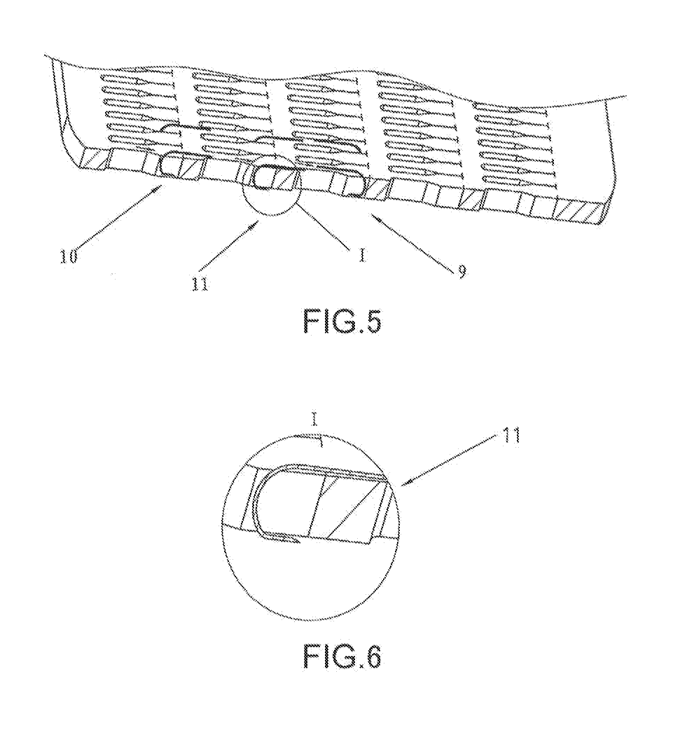

Referring to FIGS. 5-6, there are plural methods of using a holding mat with the above construction to hold flies or baits.

Method 1 (as shown by reference numeral 9 in FIG. 5): the user handholds the fly or bait to place it into the shaped slot 2, with the hook tip below and pointing to one end of the shaped slot 2 away from the cutting slit 4, and pushes the fly or bait in the cutting slit as opportunity favors to complete holding. By virtue of the accelerating function of the shaped slot 2 and the resistance-reducing function of the resistance-reducing slit 41, the fly or bait can be inserted more quickly than in the prior art.

Method 2 (as shown by reference numeral 10 in FIG. 5): the user handholds the fly or bait to place it inside the shaped slot 2, with the hook tip below and pointing to the direction of the cutting slit 4, and draws the fly or bait in the cutting slit so as to complete holding by taking advantage of the opportunities.

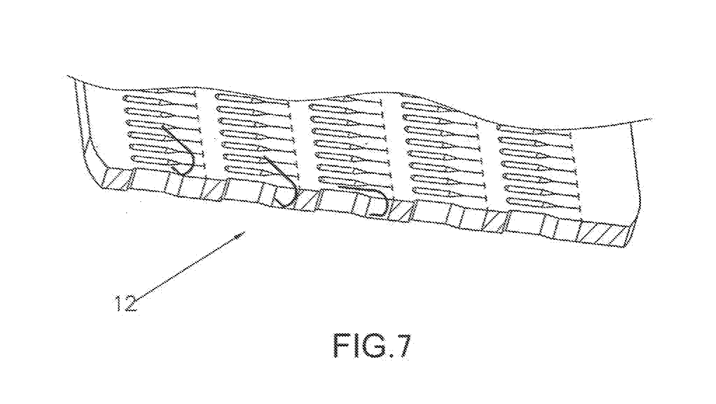

Method 3 (as shown by reference numeral 12 in FIG. 7): the user handholds the fly or bait, with the hook tip below and pointing to one end of the shaped slot 2 away from the cutting slit 4, places the bent portion of the hook portion above the conjunction between the shaped slot 2 and the cutting slit 4, and presses the fly or bait in the cutting slit so as to complete holding by taking advantage of the opportunities.

Method 4 (as shown by reference numeral 11 in FIGS. 5-6): the user handholds the fly or bait to place it inside the shaped slot 2, with the hook tip below and pointing to the direction of the cutting slit 4 so that the hook tip is located below the holding mat body, and draws the fly or bait in the cutting slit as opportunity favors to complete holding. Alternatively, holding can also be done without the fly or bait being drawn in the cutting slit.

As a result, different methods can be employed to quickly hold the flies or baits without the orientation of the hook tip of the fly or bait discerned. Accordingly, holding is fast, laborsaving and convenient. When the aforementioned method 2 or 4 is employed to pull the hook portion in the cutting slit 4, the hook tip is substantially positioned before being drawn in due to the arrangement of the independent shaped slots 2, and would not hook the sidewall to damage the hook portion or to interfere with the holding procedure.

In the example mentioned above, through the arrangement of a plurality of independent shaped slots 2 separately as well as cutting slits 4 connected thereto, insertion of the hook portion or vanes or component parts similar to vanes of the flies or baits is rendered more laborsaving and fast, and it is made possible to securely hold flies and baits of various general shapes, thereby providing flexible and reliable holding, enhancing universal applicability, and lowering costs of use. Meanwhile, the user can insert the hook portion into the cutting slit 4 in a multiplicity of modes without taking consideration of the hook portion's orientation and position relative to the holding mat, thus greatly facilitating use thereof, especially in the case of dim light.

To facilitate insertion, it is preferable to shape the shaped slot 2 thus that its size in the longitudinal extension direction of the cutting slit 4 is larger than the size in the direction that intersects the longitudinal extension direction.

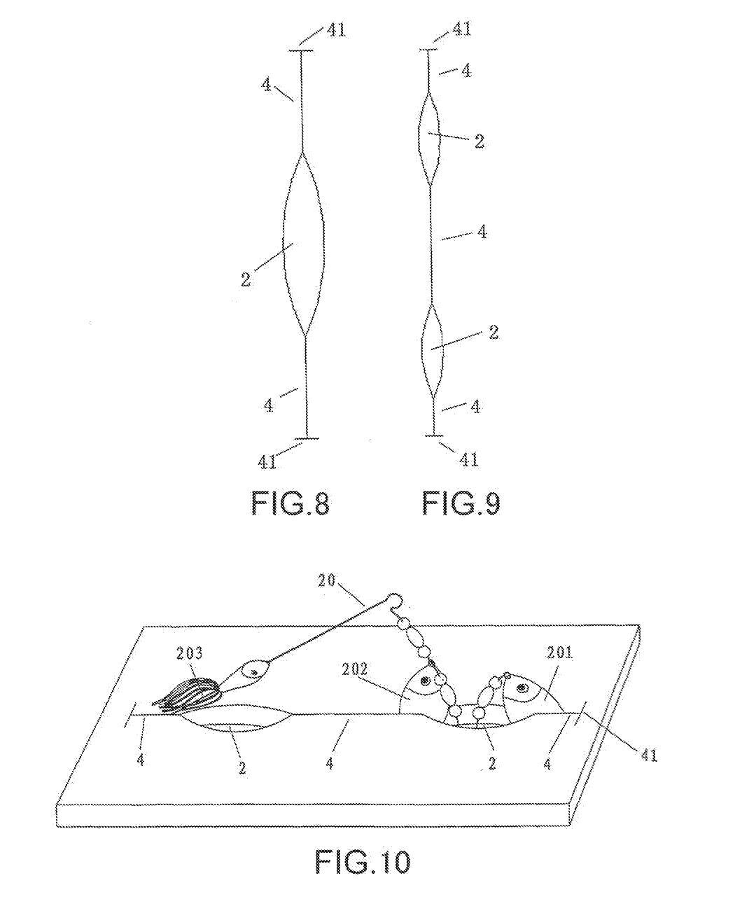

The aforementioned example is applicable to different flies or baits having only one hook and/or one hook and vane. With reference to FIGS. 8-9, different advantageous modifications of the aforementioned example are described below to adapt to flies or baits of different special shapes.

Referring to a modification shown in FIG. 8, the two ends of the shaped slot 2 are respectively provided with two cutting slits 4 and corresponding resistance-reducing slits 41 that pass through the body 1 along the thickness direction thereof. In a holding mat arranged as thus, it is possible to insert the hook portion of flies or baits with single hook into one of the cutting slits 4, and to insert vanes or similar component parts, steel wires, etc., that might be located at different positions of the flies or baits, into another cutting slit 4 as practically demanded. For example, when the holding mat according to the aforementioned modification is used to hold the L-shaped spinner baits or spoon baits, the vanes or similar component parts are aligned to the shaped slot 2 and inserted or pushed in another cutting slit 4 for holding after the single hook at one end thereof is aligned to the shaped slot 2 and pushed in one cutting slit 4. As circumstances demand, it is possible to pull one end of the steel wire of the L-shaped spinner baits placed in the shaped slot also into the cutting slit for holding.

Referring to another modification shown in FIG. 9, two shaped slots 2 are connected by a cutting slit 4 and arranged in series, and distal ends of the two shaped slots 2 are respectively provided with two cutting slits 4 and corresponding resistance-reducing slits 41 that pass through the body 1 along the thickness direction thereof. In a thus arranged holding mat, it is possible to likewise insert the hook portion of flies or baits with a single hook into one of the cutting slits 4, and to insert vanes, steel wire, ring, etc., which might be located at different positions of the flies or baits, into another cutting slit 4 as practically demanded. In the aforementioned two modifications, the guide portion 3 that is provided between the shaped slot 2 and the cutting slit 4 is not shown for the sake of brevity. For instance, referring to FIG. 10, when the holding mat according to the aforementioned modification is used to hold the L-shaped spinner bait 20, the vane 201 or similar component is aligned to another shaped slot 2 and inserted or pushed in another cutting slit 4 for holding after the single hook 203 at one end thereof is aligned to the shaped slot 2 and pushed in one cutting slit 4. As circumstances demand, it is possible to pull one end of the steel wire of the L-shaped spinner bait placed in the shaped slot also into the cutting slit for holding. FIG. 10 shows the circumstance in which no pulling-in occurs. The L-shaped spinner bait 20 as shown in FIG. 10 includes two vanes 201 and 202, and at this time the vane 202 can be aligned to another shaped slot 2 and inserted or pushed in the central cutting slit 4 for holding. FIGS. 8 and 9 are identical, where the two end points of the cutting slit are in a sealed state, and so the single hook will not eject out of the holding mat. Of course, it is also conceivable to propose an example with three or more shaped slots 2 so as to adapt to holding flies or baits of particular shapes and configurations.

Similarly, when a buzz bait having a relatively large vane is held, it is also possible to insert the vane directly into the shaped slot 2 for holding after the single hook is well held according to the foregoing method. When the holding mat shown in FIGS. 8 and 9 is used to hold L-shaped spinner baits, the holding mat should have such a thickness as sufficient to hold the hook portion, the vane or similar component parts, and the thickness should be at least 5 mm or more.

As regards spoon flies or spoon baits, after the single hook thereof is aligned to the shaped slot 2 and pushed in one cutting slit 4, one vane or similar component is then held in the cutting slit 4 between two shaped slots 2. Like the L-shaped spinner flies or baits, some flies or baits such as JIG also have a single hook and a connecting means at the head thereof to connect the vane. The method of holding the same is similar to the method of holding the L-shaped spinner flies or baits. Like the holding mat shown in FIG. 1, with the holding mat shown in FIGS. 8 and 9, flies or baits of different types can also be conveniently held. The shaped slot 2 as shown in the figures is of willow leaf shape, but it can also be of such shapes as strip, elliptical, rhombic, circular, triangular and rectangular.

As shown in FIGS. 8 and 9, it is possible to provide a guide portion in the shaped slot, and the guide portion can be of V shape, arc shape or rectangular shape. A rectangular guide portion is configured so that the vane or similar component part and the hook portion of flies or baits are smoothly pressed in the cutting slit from over the conjunction between the guide portion and the cutting slit. The vane or similar component part is placed in the shaped slot, pressed or pushed toward the cutting slit at the rectangular end, and can be relatively conveniently held due to the pre-positioning function of the shaped slot. The method of holding the flies or baits is the same as the aforementioned Method 3.

The example arrangement shown in FIGS. 8 and 9 is simple, convenient and practical, and solves problems inherent in the prior art where the products swing to cause damage in transit and it is impossible to hold the vanes. The held products, clear at a glance, are easily chosen for fishing according to different fishing sites, water depths, weathers, temperatures and timings, which solves the problem of difficult identification of the featured shapes and colors of the products placed in the box, such as whether spinner baits are of the Colorado Blade type, willow-leaf type, Indiana Blade type or composite type and whether they are white or black. Moreover, the holding mat, produced at a low cost, is convenient in the holding and use of the products, eliminating such defects inherent in the prior art as inconvenient use, high cost and the single hook of the L-shaped spinner baits easily ejecting out of the holding mat.

According to another modification, it is still possible to provide an intersecting resistance-reducing slit that extends along a direction intersecting the longitudinal extension direction of the shaped slot 2 at or near one end of the shaped slot 2 away from the cutting slit 4, and this intersecting resistance-reducing slit passes through the body 1 along the thickness direction of the body 1. Since both ends of the shaped slot 2 are provided with resistance-reducing slits, flies or baits of differing sizes, tube flies in particular, can be held.

Many types of special flies or baits currently available can be held through the modifications discussed above. As these special flies or baits have special shapes (such as L shape and R shape) and carry therewith vanes or similar parts, it is very difficult to completely hold them by means of currently available holding mats, so that there is the problem of frequent collision due to swinging en route transportation. Moreover, these products are divided into many types each having vanes of differing colors and shapes to adapt to differing environments and differing types of fish. It is usually impossible for users to visually directly observe and discern the vanes stacked below in the currently available holding mats. Whereas by means of the holding mat according to the aforementioned examples and modifications thereof, the vanes or similar component parts are inserted into the cutting slit on the surface of the holding mat, which is made possible not only to hold the vanes or similar component parts, but also to observe the vanes at a glance, thereby facilitating the user to take out the product for timely fishing.

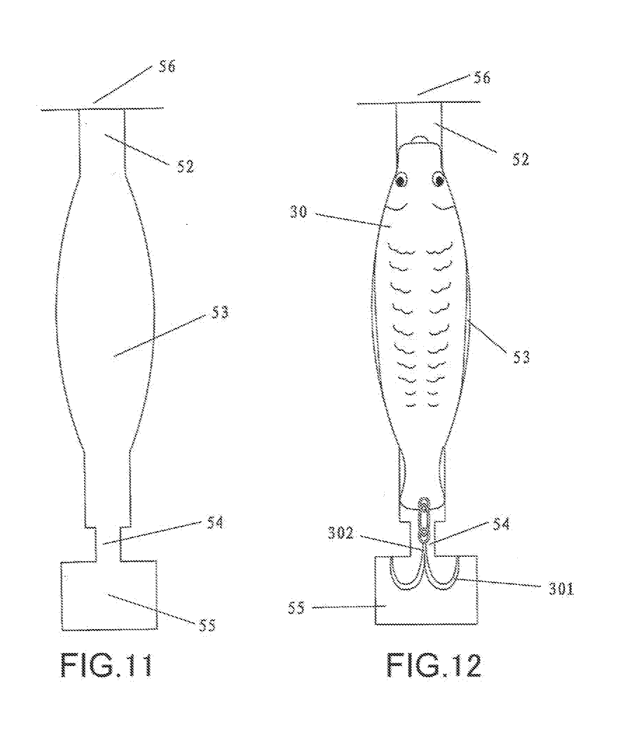

Reference is made below to FIGS. 11 and 12 to describe another example mat disclosed herein. This example mat is suitable for holding flies or baits with a plurality of hook tips. In this example, one or more shaped slot(s) 52 that are separately and substantially closed are provided on the holding mat body 1. The shaped slot 52 shown in FIG. 11 is of rectangular shape, but can also be of any other suitable shapes. The edge of the shaped slot 52 can be linear, saw-toothed, wavy or any other suitable patterns. One end of each of the shaped slots 52 is provided with a hook slot 55 for accommodating a hook portion with a plurality of hook tips at the head or tail of the flies or baits. The hook slot 55 is sized to completely accommodate the hook portion so that the hook portion does not protrude outside of the surface of the holding mat, and is designed on the principle of facilitating holding and takeout. To adapt to the hook portion, the hook slot 55 can be formed into rectangular, elliptical, semispherical, square and other various shapes. The shaped slot 52 and the hook slot 55 pass through the body 1 along the thickness direction of the body 1. Referring to FIG. 12, when this holding mat is used for holding, the hook tip of the hook portion 301 at one end of the typical bait 30 is aligned to the hook slot 55 to be pulled in for holding, and the body of the common bait 30 is then pressed in the shaped slot 52.

As shown in FIG. 11, a separation slot 54 is provided between the shaped slot 52 and the corresponding hook slot 55, and the sectional area of the separation slot 54 is smaller than that of the corresponding hook slot 55. This serves on the one hand to avoid the hook portion placed in the hook slot 55 from detaching from the hook slot 55, and on the other hand for the separation slot 54 to receive the hook stem (such as the hook stem 302 shown in FIG. 12) or to hold tube flies. The separation tube 54 can be of such suitable shapes as rectangular shape, V-shape, saw-toothed shape, and wavy shape, so as to accommodate at least one part of the hook stem or to hold the tube flies. In addition, a resistance-reducing slit 56 that intersects the longitudinal extension direction of the shaped slot 52 can be further provided at the other end of the shaped slot 52, and the resistance-reducing slit 56 passes through the body 1 along the thickness direction of the body 1. Thus, the resistance against which the body of the bait is inserted into the shaped slot 52 is reduced. Although baits have differing shapes and sizes, they have certain lengths and widths, and can hence be pressed in the slot for holding. When a bait having a relatively large width is pressed in the slot, the cutting slit opens to exert pressure on the bait, to thereby hold the bait. When relatively small bait is held, the elasticity of the holding mat body ensures reliable holding.

The aforementioned holding method is used when the width of the diving lip (a component part that controls the depth of the bait in water and the swimming posture of the bait in water; it is usually disposed below the head of the bait, and shaped mostly as a tongue) of the bait body is smaller than that of the bait body or when there is no such a diving lip. When the width of the diving lip of the common bait is larger than that of the bait body, it is possible to directly fix the diving lip in the shaped slot 52, thereby making the holding more convenient; moreover, the bait body is apparently higher than the holding mat, thereby facilitating takeout.

The example mat shown in FIG. 11 can also be employed to hold spinner flies or baits and spoon flies or baits. At this time, the treble hooks of the spinner flies or baits are placed in the hook slot 55 and the separation slot 54 and pulled in for holding, the body is then placed in the shaped slot 52, and the vanes or similar component parts are subsequently inserted into the shaped slot 52 for holding. With regard to the spoon flies or baits, the vanes or similar component parts are inserted into the shaped slot for holding after the hook portion thereof is held by the same method.

In addition, in the holding mentioned above, the vanes of the flies or baits can also be inserted into the resistance-reducing slit 56 to adapt to flies or baits with certain special structures. In the case of holding tube flies without a hook portion, the hook slot 55 can be dispensed with, and only the shaped slot 52 and the resistance-reducing slit 56 are provided. It is thus possible to insert or press in tube flies of differing tube diameters.

This technical solution solves a dilemma unsolvable for a long time in the art. By providing the hook slot to accommodate multiple hooks, the entire hook portion is accommodated in the slot, so that there is no such problem as in the prior art where one or more hook(s) stand higher than the holding mat body to hurt the user. The arrangement of the cutting slit also makes possible reliable holding of differently shaped and sized baits.

Since bait often has one or more double or treble hook(s) at the belly (or neck) or at the other end, it is possible to form a size-enlarging portion 53, that accommodates the hook portion at the belly (or neck) of the bait, in the middle or at the other end of the shaped slot 52 in order to hold such a bait. The size-enlarging portion as shown in the drawing is of arc shape, but it can also be of other such shapes as rectangular shape to adapt to the bait. Due to the presence of the size-enlarging portion, the hook at the belly or neck can be easily placed below the size-enlarging portion, and taking out of the bait is made easier at the same time. Some squid jigs do not have hook at the belly or neck, or some small quantities of baits have a width at the belly (or neck) or at the other end of the hook portion obviously smaller than the width of the bait body, so the size-enlarging portion is not required to hold them. But the size-enlarging portion is more universally applicable, and also applies to baits whose widths of the squid jig and the hook portion are smaller than that of the bait body. The arrangement of the size-enlarging portion solves the problem that dispersed distribution of hooks at the belly or neck of the baits tends to hurt the hands.

Moreover, the hook slots 55 of the shaped slots 52 can communicate with one another to form a common hook accommodating portion. This lowers the cost for molding the holding mat.

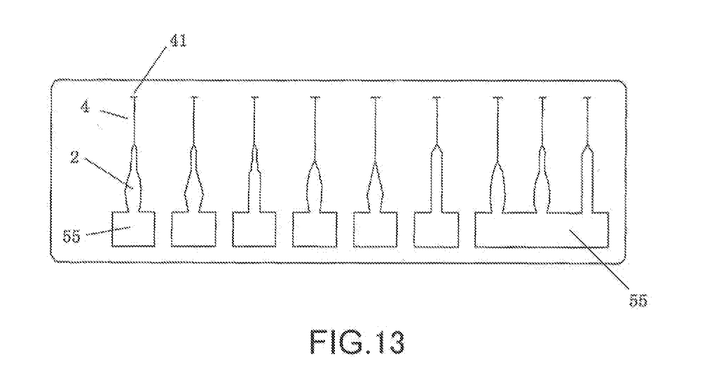

Furthermore, features of the aforementioned examples can be combined to adapt to flies or baits of particular shapes. For instance, a hook slot 55 similar to that shown in FIG. 11 can be formed at one end of the shaped slot 2 away from the cutting slit 4 as shown in FIG. 1 to obtain the two examples shown in FIGS. 13 and 14.

The example holding mat shown in FIG. 13 includes a plurality of component parts including slots and slits, and each component part includes the shaped slot 2, the cutting slit 4 and the resistance-reducing slit 41 shown in FIG. 1 and the hook slot 55 shown in FIG. 11. One end of the shaped slot 2 can also be configured as opened and in communication with the hook slot 55. As shown by the component part rightmost in FIG. 13, a plurality of hook slots 55 can be in communication with one other to form a common hook accommodating portion. The shape of the shaped slot 2 is as shown in FIG. 13, which can be such proper shapes as arc shape, arc shape in combination with rhombic shape, arc shape in combination with strip shape, rectangular shape in combination with arc shape, rectangular shape in combination with rectangular shape, elliptical shape, edge shape, strip shape, leaf shape, and rectangular shape. The hook slot 55 can be so variously shaped as to adapt to the hook portion, for instance, rectangular shape, elliptical shape, semispherical shape and square shape. A guide portion can be provided in the shaped slot in FIG. 13, and the guide portion can be of V shape, arc shape, or rectangular shape. A rectangular guide portion is configured so that the vane or similar component part and the hook portion of flies or baits are smoothly pressed in the cutting slit from over the conjunction between the guide portion and the cutting slit. The vane or similar component part is placed in the shaped slot, pressed or pushed toward the cutting slit at the rectangular end, and can be relatively conveniently held due to the pre-positioning function of the shaped slot. The method of holding the flies or baits is the same as the aforementioned Method 3.

This holding mat not only applies to holding various flies and baits held by the aforementioned examples, but also particularly applies to tube flies, treble flies, spinner flies or baits with treble hooks, spoon flies or baits with treble hooks, and other baits with a single hook. The general tube flies can be pressed or inserted into the shaped slot 2 for holding. Due to the opening at the end where the shaped slot 2 is connected with the hook slot 55, it is easy for variously sized tube flies to be inserted or pressed in, and the cutting slit 4 and the resistance-reducing slit 41 at the other end of the shaped slot 2 make possible the reliable holding of these differently sized tube flies. As regards the relatively short treble flies, the tail of the flies can be handheld to be directly held in the separation slot (not shown in the figure) between the hook slot 55 and the shaped slot 2, and it is alternatively possible to press the treble flies downwards, and to hold the flies on the upper surface of the holding mat body with the tail hairs pointing upwards. As regards long treble tube flies, their hooks are aligned to the hook slot and pulled in, while their heads are pressed in the section having a smaller sectional area at the upper portion of the shaped slot 2. As regards baits with treble hooks such as the spinner baits, it is possible to hold the treble hooks in the hook slot 55, then simultaneously place the vane and the bait body in the shaped slot 2, and insert or press the vane or similar component part in the cutting slit 4 through the shaped slot 2 for holding. It is also possible to hold the treble hooks in the hook slot 55, then place the bait body in the shaped slot, and insert or press the vane or similar component part in the cutting slit 4 through the shaped slot 2 for holding. As regards spoon flies or baits with treble hooks, it is possible to hold the treble hooks in the hook slot 55, and then insert or press the vane or similar component part in the cutting slit 4 through the shaped slot 2 for holding. Due to the arrangement of the resistance-reducing slit 41, the cutting slit 4 and the shaped slot 2, various vanes or similar component parts with differing thicknesses can be easily inserted or pressed in the cutting slit 4 for holding. As regards common baits with single hook, the hook is pushed in the cutting slit 4, and the body of the common baits is held in the shaped slot 2. The hook slot 55 also functions to guide and reduce resistance because the shaped slot is in communication with the hook slot. Holding of flies and baits is only partially illustrated above by way of examples, but the holding mat is also applicable to various flies and baits including tube flies due to the synergic function of the resistance-reducing slit 41, the cutting slit 4, the shaped slot 2 and the hook slot 55, and is hence universally applicable. Moreover, the holding mat is convenient in both holding and takeout, and low in cost.

The holding mat shown in FIG. 14 includes plural sets of shaped slots 6 and 6′. Each set of shaped slots includes plural shaped slots 2, cutting slits 4 and resistance-reducing slits 41 as shown in FIG. 1 and hook slots 55 as shown in FIG. 11. The hook slot 55 can be formed into rectangular, elliptical, semispherical, square and other various shapes so as to adapt to the hook portion. The shaped slot 2 is opened at one end to communicate with the hook slot 55. As shown in FIG. 14, hook slots 55 communicating with the shaped slots 2 communicate with one another to form a common hook accommodating portion. In FIG. 14, another cutting slit 42 is further provided near the end of the shaped slot 2 close to the cutting slit 4, and the cutting slit 42 intersects the longitudinal extension direction (the perpendicular direction in FIG. 14) of the shaped slot 2. The cutting slit 42 functions identically with the resistance-reducing slit 41 does, both for facilitating insertion or pressing of variously sized tube flies in the shaped slot 2. The holding mat shown in FIG. 14 can hold various flies and baits including tube flies in the same manner as the holding mat shown in FIG. 13. A guide portion can be provided in the shaped slot in FIG. 14, and the guide portion can be of V shape, arc shape, or rectangular shape. A rectangular guide portion is configured so that the vane or similar component part and the hook portion of flies or baits are smoothly pressed in the cutting slit from over the conjunction between the guide portion and the cutting slit. The vane or similar component part is placed in the shaped slot, pressed or pushed toward the cutting slit at the rectangular end, and can be relatively conveniently held due to the pre-positioning function of the shaped slot. The method of holding the flies or baits is the same as the aforementioned Method 3.

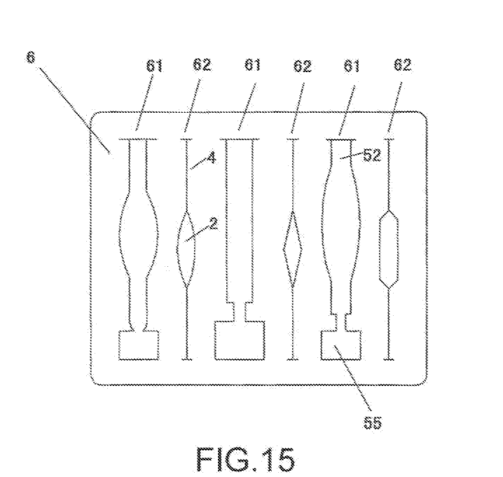

Moreover, as shown in FIG. 15, a component part 62 including the shaped slot 2 and the cutting slit 4 as shown in FIGS. 1, 8 and 9 as well as a component part 61 including the shaped slot 52 and the hook slot 55 as shown in FIG. 10 can be included in the same set of shaped slots 6. It is thus possible to hold the aforementioned various flies or baits in the same and single holding mat. In addition, alternately-arranged component parts 61 and 62 are particularly suitable for holding the special thunder striker baits, which also include treble hooks and vanes, similar to a gate shape. However, unlike other L-shaped spinner baits, at one end of the thunder striker bait is provided the treble hooks rather than the single hook. Such baits may not be held with the single components 61 or 62, but can be held with the holding mat shown in FIG. 15. The treble hooks are firstly aligned to the hook slot 55 and pulled in so that the hooks are held at the edge of the hook slot 55 of the component part 61, the bait body is then held in the shaped slot 52 which is connected with the hook slot 55, and the vanes are subsequently inserted into the shaped slot 2 or cutting slit 4 of the adjacent component part 62. It is also possible for the component part 62 in FIG. 15 to be in the form of component part with two shaped slots as shown in FIG. 9, and hook slots 55 of a plurality of component parts 61 can also communicate with one another as shown in FIG. 14 to form a common hook accommodating portion. Additionally, the component part 62 can also be replaced with a component part including the shaped slot 2, the cutting slit 4, the resistance-reducing slit 41 and the hook slot 55 as shown in FIG. 13.

From the foregoing, it will be appreciated that universal holding mats have been disclosed that are simple in structure, fast in holding and convenient in use. Such holding mats not only apply to holding flies during fly fishing but also apply to holding baits during sport fishing.

A disclosed example mat for holding flies or baits comprises a holding mat body made of a foamed material, and one or more shaped slot(s) disposed separately on the body. The shaped slots pass through the body along a thickness direction of the body. One end of the shaped slot is connected with a cutting slit that passes through the body along the thickness direction of the body, and the cutting slit is used to hold the hooks, vanes or similar components of the flies or baits.

The other end of the shaped slot can also be provided with a cutting slit that passes through the body along the thickness direction of the body.

An example holding mat can further comprise one or more additional shaped slot(s) disposed separately and corresponding to each of the shaped slots, wherein one end of each additional shaped slot is connected with the shaped slot via a central cutting slit, the other end thereof is further connected with another cutting slit, and the additional shaped slot and the cutting slit both pass through the body along the thickness direction of the body.

Another end of the shaped slot can be provided with a hook slot that accommodates a hook portion.

In some examples, a resistance-reducing slit that extends along a direction intersecting the longitudinal extension direction of the shaped slot is provided at or near the other end of the shaped slot, and the resistance-reducing slit passes through the body along the thickness direction of the body.

In some examples, a guide portion can be provided between the shaped slot and the cutting slit connected thereto for guiding the hook portion or vanes or similar components to be inserted into the cutting slit.

The guide portion can be of a V shape, arc shape or rectangular shape.

In some examples, the holding mat further comprises a resistance-reducing slit that intersects the cutting slit for reducing resistance when the hook portion or vanes is/are inserted into the cutting slit, and the resistance-reducing slit passes through the body along a thickness direction of the body. The resistance-reducing slit and the cutting slit form a “T” shape, a “Y” shape, a “+” shape or an arrow shape.

In some examples, a plurality of shaped slots are arranged in parallel to form a set of shaped slots. The body is provided with a plurality of sets of shaped slots arranged in parallel. The shaped slot can be of strip shape, elliptical shape, leaf shape, rhombic shape, circular shape, triangular shape or rectangular shape.

In some examples, at least one part of the holding mat is fixed to an accommodating box by a binding means. In some such example, only the part of the holding mat that is not provided with the cutting slit or the shaped slot is fixed to the accommodating box by the binding means. The binding means can be a double faced adhesive tape or an adhesive.

Some disclosed example mats for holding flies or baits include a holding mat body made of a foamed material, and one or more shaped slot(s) disposed separately on the body, wherein one end of each of shaped slots is provided with a hook slot for accommodating a hook portion located at one end of the fly or bait, and the shaped slot and the hook slot pass through the body along a thickness direction of the body.

Methods of holding baits in the aforementioned holding mats are also disclosed. In some such methods, the baits have a hook portion with more than one hook tip at one end thereof, and the method comprises aligning the hook tips of the hook portion at one end to a hook slot, drawing in to fix; and pressing a body of the baits into a shaped slot.

In some examples, a resistance-reducing slit that intersects the longitudinal extension direction of each of the shaped slots is provided at the other end of each of the shaped slots, and the resistance-reducing slit passes through the body along the thickness direction of the body.

In some such examples, the shaped slot includes a size-enlarging portion for accommodating the hook portion of the flies or baits, or another hook portion. The size-enlarging portion can have an arc shape or a rectangular shape, or can have any other proper shape.

In some examples, the hook slots of the shaped slots can communicate with one another to form a common hook accommodating portion.

In some examples, a separation slot is provided between each of the shaped slots and the corresponding hook slot respectively, and a sectional area of the separation slot is smaller than that of the corresponding hook slot.

Some disclosed example mats for holding flies or baits include a holding mat body made of a foamed material, one or more cutting slit(s) disposed separately on the body, and a resistance-reducing slit that extends to intersect the cutting slit at or near one end of the cutting slit. The cutting slit and the resistance-reducing slit pass through the body along a thickness direction of the body, and the other end of each cutting slit opens to allow insertion thereto of a hook portion or vanes or similar component parts of the flies or baits.

Methods of holding flies or baits having vanes in a holding mat, which comprises a holding mat body made of a foamed material and a plurality of cutting slits disposed separately away from one another on the body and passing through the body are disclosed. Some example methods comprise aligning the hook tips of the hook portion at one end to a hook slot, drawing in to fix; and pressing a body of the baits into a shaped slot.

Some of the above disclosed examples exhibit one or more of the following advantages:

(1) Disclosed example mats are a success in holding various types of flies and baits. Since some such mats provide the resistance-reducing slit, cutting slits, shaped slots, hook slots, etc., the problem of holding many different (in some instances all) types of flies and baits with single hook, double hooks, treble hooks and two multiple hooks is solved, thereby eliminating the need for having multiple difference fly or bait holding devices as in the prior art. Specifically, by providing the slit, the cutting slits, the shaped slots, etc., the problem of holding various flies and baits with a single hook as well as holding tube flies is solved. By providing the resistance-reducing slit, the cutting slits, the shaped slots, the hook slots, etc., various flies and baits with double hooks, treble hooks and two multiple hooks are reliably held, for instance with regard to spinner baits. This solves a problem that has heretofore been unsolvable for a long time in the art.

(2) Some of the disclosed example mats have universal application, and save fishing costs. An example holding mat is applicable to flies or baits of various shapes, sizes and types, as flies and baits with different specifications of hooks can be smoothly and conveniently pushed, pulled or pressed from up to down into the cutting slit for holding or drawn from below the body for holding. Accordingly, only one fly- or bait-holding mat is needed for holding flies and baits, thus achieving multifunction with one product. This saves not only space but also cost for anglers. Such mats can bring even more convenience and cost-efficiency to anglers who like both fly fishing and sport fishing. The problems of low universality and high cost inherent in the prior art, where different holding mats are required for different types of flies, is, thus, solved

(3) Disclosed example mats are fast, laborsaving and secure in holding. Due to the pre-positioning and accelerating functions of the shaped slot, the hook portion or vanes of the flies or baits can smoothly slide into the cutting slit. Arrangement of the cutting slit at a proper position enables convenient insertion of the vanes into the cutting slit, so that flies or baits of various shapes and constructions, such as L-shaped spinner baits, can be reliably held. Since the cutting slit is sealed at both ends thereof, the hook cannot eject out of the holding mat. The combination of the resistance-reducing slit with the cutting slit reduces the resistance against the insertion into the cutting slit at the same time of ensuring the holding force. The problems inherent in the prior art, where it is impossible to hold the vanes and the hook of the R-shaped (or L-shaped) spinner baits would eject out of the foamed strip, are solved.

(4) Tube flies, bait bodies and vanes can be placed or held by the shaped slots. The problems inherent in the prior art are solved where tube flies cannot be reliably held, and bait bodies and vanes cannot be placed or held.

(5) By providing a hook slot for placing a hook portion with a plurality of hook tips, hook tips of treble hooks are not exposed above the surface of the holding mat, thus enabling reliable holding of flies or baits with a plurality of hook tips, such as tube flies, spoon baits with double hooks, treble hooks and multiple hooks, spinner baits and common baits, thereby solving the problem in the prior art where the exposure of two hooks in the treble hooks out of the surface of the holding mat easily hurts the hand.

(6) By providing a size-enlarging portion of the shaped slot, double hooks or treble hooks located at the neck or belly of baits can be placed, thereby solving a difficult problem previously unsolvable in the art.

(7) By providing a resistance-reducing slit of the cutting slit along the longitudinal direction of the shaped slot, baits with differing shapes and sizes can be smoothly, quickly and reliably held.

(8) Further, plural methods are disclosed herein to hold flies or baits. Accordingly, it is unnecessary for users to discern the orientation of hook tips of the flies or baits, as the flies and baits can be quickly held by employing different methods. This solves the problem of monotony in holding methods in the prior art.

(9) The features of flies or baits held by holding mats disclosed herein are externally and easily discernible, which facilitates the use of the flies or baits and solves the problem of inconvenient use in the prior art where it is not easy to identify the vanes of the L-shaped spinner baits and/or L-shaped spinner flies placed at the bottom of the box.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

1. A mat for holding flies and baits, comprising a holding mat body made of a foamed material, and one or more shaped slots disposed separately from one another on the body, characterized in that
the shaped slot passes through the body along a thickness direction of the body, and a resistance-reducing slit that extends along a direction intersecting a longitudinal extension direction of the shaped slot is provided at or near an end of the shaped slot, the resistance-reducing slit passing through the body along the thickness direction of the body.

2. A mat for holding flies and baits, comprising a holding mat body made of a foamed material, and one or more shaped slots disposed separately from one another on the body, characterized in that
the shaped slot passes through the body along a thickness direction of the body, a cutting slit that passes through the body along the thickness direction of the body is connected at one or both ends of the shaped slot, and the body is further provided with a resistance-reducing slit that intersects the cutting slit, the resistance-reducing slit passing through the body along the thickness direction of the body.

3. The mat for holding flies and baits according to claim 2, characterized in that a resistance-reducing slit that extends along a direction intersecting a longitudinal extension direction of the shaped slot is provided at or near an end of the shaped slot, the resistance-reducing slit passing through the body along the thickness direction of the body.

4. The mat for holding flies and baits according to claim 1, characterized in further comprising one or more additional shaped slots disposed separately from one another and corresponding to each of the shaped slots, wherein one end of each additional shaped slot is connected to the shaped slot via a central cutting slit, the other end thereof is further connected with another cutting slit, and the additional shaped slot and the cutting slit both pass through the body along the thickness direction of the body.

5. The mat for holding flies and baits according to claim 2, characterized in further comprising one or more additional shaped slots disposed separately from one another and corresponding to each of the shaped slots, wherein one end of each additional shaped slot is connected to the shaped slot via a central cutting slit, the other end thereof is further connected with another cutting slit, and the additional shaped slot and the cutting slit both pass through the body along the thickness direction of the body.

6. The mat for holding flies and baits according to claim 2, characterized in that the cutting slit connected with one shaped slot is oriented opposite the cutting slit connected with another shaped slot, so as to hold R-shaped or L-shaped spinner baits.

7. The mat for holding flies and baits according to claim 1, characterized in that the shaped slot comprises a size-enlarging portion for receiving a hook portion near a belly or neck of the baits or for facilitating handling of the flies and baits.

8. The mat for holding flies and baits according to claim 2, characterized in that the shaped slot comprises a size-enlarging portion for receiving a hook portion near a belly or neck of the baits or for facilitating handling of the flies and baits.

9. The mat for holding flies and baits according to claim 1, characterized in that the shaped slot that is connected with the cutting slit or the resistance-reducing slit at one end is open at the other end, and the shaped slot comprises a small shaped slot portion with a small cross-sectional area at the end connected with the cutting slit or the resistance-reducing slit, and a large shaped slot portion with a large cross-sectional area at the other end that is open.

10. The mat for holding flies and baits according to claim 2, characterized in that the shaped slot that is connected with the cutting slit or the resistance-reducing slit at one end is open at the other end, and the shaped slot comprises a small shaped slot portion with a small cross-sectional area at the end connected with the cutting slit or the resistance-reducing slit, and a large shaped slot portion with a large cross-sectional area at the other end that is open.

11. The mat for holding flies and baits according to claim 1, characterized in that the shaped slot that is connected with the cutting slit or the resistance-reducing slit at one end is open at the other end and is communicative with a hook slot for receiving a hook portion.

12. The mat for holding flies and baits according to claim 2, characterized in that the shaped slot that is connected with the cutting slit or the resistance-reducing slit at one end is open at the other end and is communicative with a hook slot for receiving a hook portion.

13. The mat for holding flies and baits according to claim 11, characterized in that the cross-sectional area of the hook slot is larger than the cross-sectional area of the shaped slot.

14. The mat for holding flies and baits according to claim 12, characterized in that the cross-sectional area of the hook slot is larger than the cross-sectional area of the shaped slot.

15. The mat for holding flies and baits according to claim 11, characterized in that each shaped slot is communicative with the corresponding hook slot via a separation slot, the cross-sectional area of the separation slot being smaller than the cross-sectional area of the corresponding hook slot.

16. The mat for holding flies and baits according to claim 12, characterized in that each shaped slot is communicative with the corresponding hook slot via a separation slot, the cross-sectional area of the separation slot being smaller than the cross-sectional area of the corresponding hook slot.

17. The mat for holding flies and baits according to claim 2, characterized in that a guide portion is provided between the shaped slot and the cutting slit connected therewith, the guide portion being of V shape, arc shape or rectangular shape.

18. The mat for holding flies and baits according to claim 2, characterized in that two shaped slots are provided that are connected with one cutting slit and arranged in series, and two cutting slits that pass through the body along the thickness direction of the body are respectively provided at the unconnected ends of the two shaped slots.

19. The mat for holding flies and baits according to claim 2, characterized in that the resistance-reducing slit is provided at or near one end of the cutting slit away from the shaped slot.

20. The mat for holding flies and baits according to claim 2, characterized in that the resistance-reducing slit and the cutting slit form a “T”-shaped set of cutting slits, a “Y”-shaped set of cutting slits, a “+” shaped set of cutting slits, or an arrow shaped set of cutting slits.

21. The mat for holding flies and baits according to claim 5, characterized in that the mat for holding the R-shaped or L-shaped spinner baits has a thickness of 5 mm or more.

22. The mat for holding flies and baits according to claim 1, characterized in that each of the separately disposed shape slots is open for positioning or holding the flies and baits, positioning the hook portion of the flies and baits and accelerating insertion thereof into the cutting slit, or holding tube flies, or holding a baits body, or holding the diving lip of the baits body, or positioning or holding a spoon vane, or placing one end of the spinner flies and baits.

23. The mat for holding flies and baits according to claim 2, characterized in that each of the separately disposed shape slots is open for positioning or holding the flies and baits, positioning the hook portion of the flies and baits and accelerating insertion thereof into the cutting slit, or holding tube flies, or holding a baits body, or holding the diving lip of the baits body, or positioning or holding a spoon vane, or placing one end of the spinner flies and baits.

24. The mat for holding flies and baits according to claim 2, characterized in that an adhesive or a double faced adhesive tape is attached to a backside of the body and outer sides of the shaped slot and the cutting slit.

25. The mat for holding flies and baits according to claim 1, characterized in that the shaped slot is open at one end.

26. The mat for holding flies and baits according to claim 2, characterized in that the shaped slot is open at one end.

27. The mat for holding flies and baits according to claim 11, characterized in that the hook slots of a plurality of the shaped slots are communicative with one another to form a common hook slot.

28. The mat for holding flies and baits according to claim 12, characterized in that the hook slots of a plurality of the shaped slots are communicative with one another to form a common hook slot.

29. A method for holding flies and baits in a mat for holding flies and baits according to claim 2, comprising:
the method for holding the flies and baits:
placing the flies or baits in a shaped slot with a user's hand holding them, with a hook tip resting below and pointing to the direction of a cutting slit so that the hook tip locates below a holding mat body, and drawing the flies or baits in the cutting slit as opportunity favors to complete the holding; alternatively, effecting the holding without drawing the flies or baits in the cutting slit;
method for holding flies and baits having vanes or vanes connected by a circular ring at the other end thereof:
(a) method for holding R-shaped spinner baits:
pushing a hook of the R-shaped spinner baits in the cutting slit, and inserting or pressing spinner vanes at the other end of the R-shaped spinner baits in another cutting slit;
(b) method for holding spoon baits:
pushing a hook of the spoon baits in the cutting slit, and inserting or pressing vanes of the spoon baits in another cutting slit;
method for holding flies or baits with multiple hooks:
aligning a hook portion to a hook slot, a separation slot, or a hook slot, a shaped slot, and drawing it in for holding; and
pressing a body of the flies and baits in the shaped slot for holding, or pressing a diving lip of a head of the baits body in the shaped slot for holding, or pressing vanes of the spinner baits or spoon baits in the shaped slot or the cutting slit for holding;
or pressing one end of tube flies in the shaped slot for holding;
method for holding tube flies:
pressing the tube flies in an opened shaped slot with a resistance-reducing slit or a cutting slit for holding.

30. A mat for holding flies and baits, comprising a holding mat body made of a foamed material, and one or more shaped slots disposed separately from one another on the body, characterized in that
the shaped slot passes through the body along a thickness direction of the body, and cutting slits that pass through the body along the thickness direction of the body are provided at both ends of each shaped slot.

31. The mat for holding flies and baits according to claim 30, characterized in that two shaped slots are connected with each other via the cutting slits at their ends to form two shaped slots arranged in series.

32. The mat for holding flies and baits according to claim 30, characterized in that a resistance-reducing slit is provided on the cutting slit.

33. A mat for holding flies and baits, comprising a holding mat body made of a foamed material, and one or more shaped slots disposed separately from one another on the body, characterized in that one end of each shaped slot is connected with a cutting slit or a resistance-reducing slit, and the shaped slot is open at the other end thereof.

34. The mat for holding flies and baits according to claim 33, characterized in that the resistance-reducing slit extends along a direction intersecting a longitudinal extension direction of the shaped slot.

35. The mat for holding flies and baits according to claim 33, characterized in that the resistance-reducing slit is provided on the cutting slit.

36. The mat for holding flies and baits according to claim 35, characterized in that the resistance-reducing slit and the cutting slit form a “T”-shaped set of cutting slits, a “Y”-shaped set of cutting slits, a “+” shaped set of cutting slits, or an arrow shaped set of cutting slits.
